(19) United States
(12) Patent Application Publication
(10) Pub. No.: US 2002/0141848 A1
(43) Pub. Date: Oct. 3, 2002

(54) WOOD SCREW WITH HELICAL TETRAGONAL THREAD

(76) Inventors: Sui-Chin Hsu, Tu-Cheng City (TW); Sung-Pai Cho, Hsin-Chuang City (TW)

Correspondence Address: Bruce H Troxell, 5205 Leesburg Pike, Suite 1404, Falls Church, VA, 22041, US

(21) Appl. No.: 09/818,776

(22) Filed: Mar. 28, 2001

(51) Int. Cl. F16B 35/04

(52) U.S. Cl. 411/411

(57) ABSTRACT

An improved screw structure to be used exclusively for the wood plate mainly comprises of a smooth shank on the upper end portion of the screw body, the round thread teeth on the intermediate section and the helical thread teeth in tetragonal shapes on the lower end portion, wherein the pointed portions of the tetragonal thread teeth are arranged at different angles for cutting the wooden materials being drilled; furthermore, since the tetragonal shapes of the thread teeth reduce the frictional force occurred during the screwing process, the operation becomes more labor saving, works fast and prevents the wooden materials from being cracked.

### BACKGROUND OF THE INVENTION

1) Field of the Invention

The invention herein relates to an improved screw structure to be used exclusively for the wood plate, especially a screw structure using the cutting by the tetragonal thread teeth to the wooden materials to reduce the frictional force and make the screwing movement more labor saving and prevent the wood plate from being cracked.

2) Description of the Prior Art

The conventional screws for screwing the wooden materials, as shown in FIG. 1, usually have the round thread teeth (12) in helical shapes on the screw body (11); the screw (1) will be fastened by gradually screwing the helical round thread teeth (12) into the wooden materials; however, some of the textures of the wooden materials are too hard to be easily drilled by this kind of screws (1); furthermore, the cutting caused by the thread teeth (12) is not smooth enough, therefore, the surface of the wooden materials (2) usually cracks during the screwing process due to the improper force exertion, as shown in FIG. 2. It is not an ideal structure since it not only influences the presentation, but also causes the unsafe fastening and loosening, disables the full function of the screw (1) and lacks the efficiency of labor saving. These various shortcomings have always troubled the general manufacturers and the customers and also have been criticized by them. Therefore, the necessity of providing an improved screw structure, with specifically enhanced efficiency and promoted practical value of the product, to be used exclusively for the wood plate, is the motive of the innovation of the invention herein.

### SUMMARY OF THE INVENTION

The primary objective of the invention herein is to provide an improved screw structure, to be used exclusively for the wooden materials, comprising of a screw body with a smooth shank on the upper end portion of the main body, round thread teeth on the intermediate section and with helical thread teeth in tetragonal shapes on the lower end portion, with the pointed portions of the tetragonal thread teeth arranged at different angles to allow the tetragonal shapes to cut the wooden materials being drilled to reduce the frictional force occurred during the spinning so as to achieve the efficiency of labor saving in operation.

Another objective of the invention herein is to have the same kind of helical thread teeth in tetragonal shapes on the lower end portion to be mounted on the upper end portion of the screw body for adapting to wooden materials with different textures.

To enable a further understanding of the main features and innovation of the invention herein, the brief description of the drawings below is followed by the detailed description of the preferred embodiments.

### BRIEF DESCRIPTION OF THE DRAWINGS

FIG. 1 is an isometric drawing of a conventional screw.

FIG. 2 is an isometric drawing of a preferred embodiment of a screwed conventional screw.

FIG. 3 is a pictorial and isometric drawing of the invention herein.

FIG. 4 is an isometric drawing of the invention herein in preferred embodiment.

FIG. 5 is a top view drawing of the invention herein in preferred embodiment.

FIG. 6 is another pictorial and isometric drawing of the invention herein in preferred embodiment.

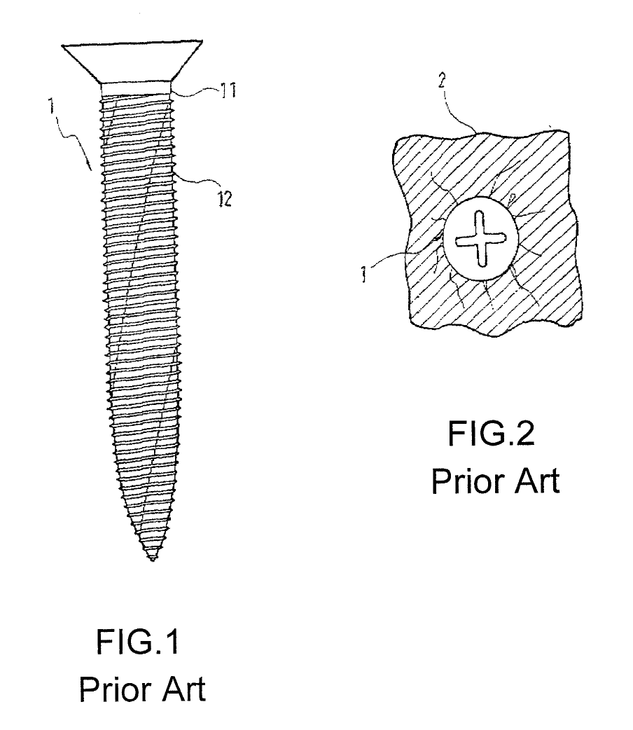

### DETAILED DESCRIPTION OF PREFERRED EMBODIMENTS

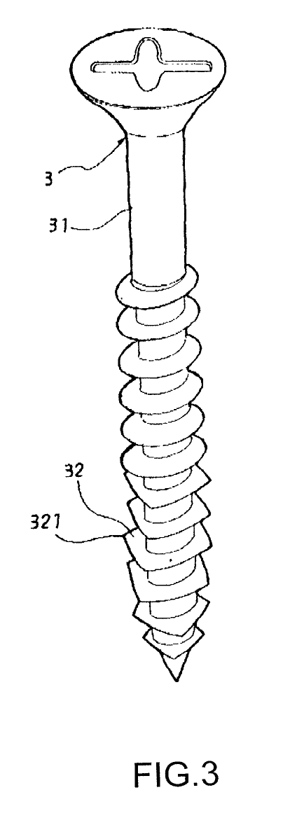

Referring to FIG. 3, the pictorial and isometric drawing of the invention herein, the invention herein mainly comprises of a screw body (3) with a smooth shank (31) on the upper end, the round thread teeth (33) on the intermediate section, and with the helical and tetragonal thread teeth (32) on the lower end; the pointed portions (321) of the tetragonal thread teeth (32) are arranged at different angles from the top to the bottom; the cutting of the pointed portions (321) by the tetragonal thread teeth (32) to the wooden materials will benefit the screwing in the entire screw body (3) and reducing the frictional force due to the tetragonal shapes so as to achieve the efficiency of labor saving.

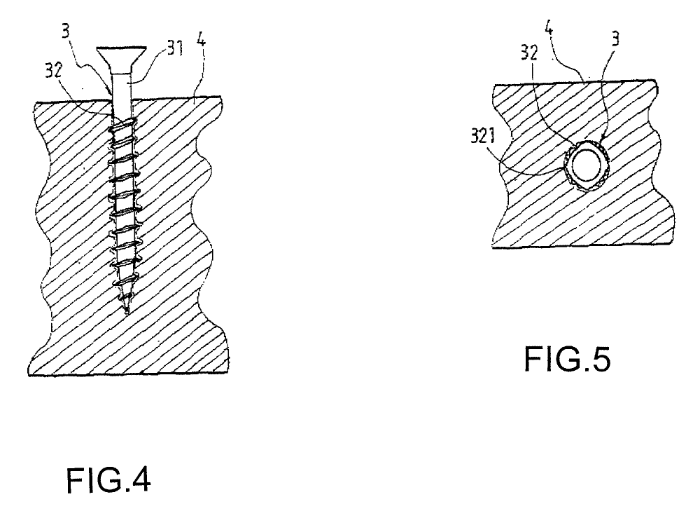

Referring to FIG. 4, the isometric drawing of the invention herein in preferred embodiment, when in use, the pointed portions (321) of the tetragonal thread teeth (32) gradually cut into the wooden materials (4) to not only make the screw body (3) easily screw in, but also make the shank (31) on the upper end easily house in after the tetragonal thread teeth (32) being screwed in entirely, therefore the whole screw body (3) will embed in the wooden materials (4), as shown in FIG. 5 of the top view drawing of the invention herein in a preferred embodiment; when the invention herein in use, the pointed portions (321) of the tetragonal thread teeth (32) gradually cut into the wooden materials (4), since the four sides of the thread teeth (32) do not contact the wooden materials (4), the frictional force occurred during the screwing will be reduced to make the screwing operation more labor saving and prevent the wooden materials (4) from being cracked.

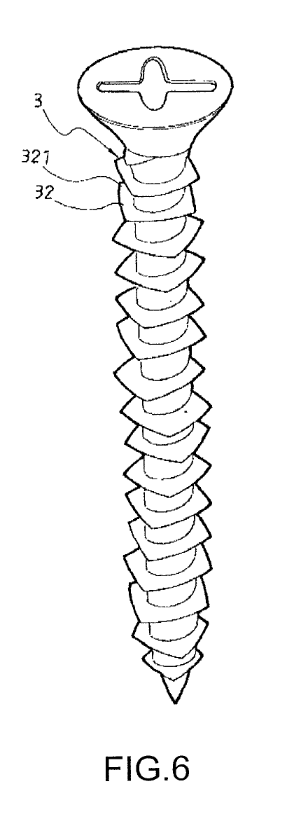

Referring to FIG. 6, the another pictorial and isometric drawing of the invention herein in preferred embodiment, the same kind of helical and tetragonal thread teeth (32) on the lower end can be mounted on the upper end and intermediate portion of the screw body (3) for adapting to screwing the wooden materials with different textures.

In summation of the foregoing sections, the design of using the tetragonal and helical thread teeth of the invention herein to achieve the efficiency of labor saving while screwing the screw into the hardwood is practical and an invention of innovation; therefore the invention herein fully complies with all new patent application requirements and is hereby submitted to the patent bureau for review and the granting of the commensurate patent rights.

1. An improved screw structure to be used exclusively for the wood plate mainly comprising of a screw body with a smooth shank on the upper end portion is characterized in that:
the portion of the screw body below the round thread teeth is mounted with helical and tetragonal thread teeth to make the four pointed portions of the thread teeth arranged at different angles so as to achieve the efficiency of labor saving through the cutting by the tetragonal thread teeth to the wooden materials while the screw is screwed to the hardwood.
